(19) United States
(12) Patent Application Publication
(10) Pub. No.: US 2024/0029333 A1
(43) Pub. Date: Jan. 25, 2024

(54) HYBRID REPRESENTATION FOR PHOTOREALISTIC SYNTHESIS, ANIMATION AND RELIGHTING OF HUMAN EYES

(71) Applicant: GOOGLE LLC, Mountain View, CA (US)

(72) Inventors: Abhimitra Meka, San Francisco, CA (US); Thabo Beeler, Egg (CH); Franziska Müller, Zurich (CH); Gengyan Li, Volketswil (CH); Marcel Bühler, Truttikon (CH); Otmar Hilliges, Zurich (CH)

(21) Appl. No.: 18/355,154

(22) Filed: Jul. 19, 2023

Related U.S. Application Data
(60) Provisional application No. 63/368,933, filed on Jul. 20, 2022.

(51) Int. Cl. G06T 13/40; G06T 17/20; G06T 15/50

(52) U.S. Cl. CPC G06T 13/40; G06T 17/20; G06T 15/50; G06T 2210/62; G06T 2210/44

(57) ABSTRACT

A method including selecting a first point from a 3D model representing an avatar, the first point being associated with an eye, selecting a second point from the 3D model, the second point being associated with a periocular region associated with the eye, generating an albedo and spherical harmonics (SH) coefficients based on the first point and the second point, and generating an image point based on the albedo, and the SH coefficients.

### FIELD

This application claims the benefit of U.S. Provisional Application No. 63/368,933, filed Jul. 20, 2022, the disclosure of which is incorporated herein by reference in its entirety.

### FIELD

Implementations relate to modeling an eye region of content in an image and/or a mesh representing an image and synthesizing an image using the modeled eye region.

### BACKGROUND

A unique challenge in creating high-quality animatable and relightable 3D avatars of real people is modeling human eyes, particularly in conjunction with the surrounding periocular face region. The challenge of synthesizing eyes is multifold as it can require 1) appropriate representations for the various components of the eye and the periocular region for coherent viewpoint synthesis, capable of representing diffuse, refractive and highly reflective surfaces, 2) disentangling skin and eye appearance from environmental illumination such that it may be rendered under novel lighting conditions, and 3) capturing eyeball motion and the deformation of the surrounding skin to enable re-gazing.

### SUMMARY

This subject matter is targeted to a hybrid representation that combines mesh based and volumetric reconstruction to achieve animatable synthesis of the eye region under desired environmental lighting. The implementations described the use of a light-weight capture system consisting of a small number of static cameras and lights along with a single hand-held camera with a co-located light source. The implementations describe a model the eyeball surface as an explicit mesh and the canonical shape of the periocular skin region and the interior eye volume using an implicit volumetric representation.

In a general aspect, a device, a system, a non-transitory computer-readable medium (having stored thereon computer executable program code which can be executed on a computer system), and/or a method can perform a process with a method including identifying an eye in a three-dimensional (3D) model representing an avatar, selecting a first point from the 3D model based on the identified eye, selecting a second point from the 3D model based on the identified eye, transforming the first point, warping the second point, generating an albedo and spherical harmonics (SH) coefficients based on the transformed first point and the warped second point, generating an image point based on the albedo and the SH coefficients.

In another general aspect, a device, a system, a non-transitory computer-readable medium (having stored thereon computer executable program code which can be executed on a computer system), and/or a method can perform a process with a method including selecting a first point from a 3D model representing an avatar, the first point being associated with an eye, selecting a second point from the 3D model, the second point being associated with a periocular region associated with the eye, generating an albedo and spherical harmonics (SH) coefficients based on the first point and the second point, and generating an image point based on the albedo, and the SH coefficients.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a block diagram of a data flow for synthesizing an image according to an example implementation.

FIG. 2 illustrates a portion of a human face including an eye and a periocular region according to an example implementation.

FIG. 3 illustrates an eye model according to an example implementation.

FIG. 4 illustrates a block diagram of a data flow for synthesizing an image according to an example implementation.

FIG. 5 illustrates a block diagram of a Neural Radiance Fields (NeRF) with Spherical Harmonics Lighting (SHL) model according to an example implementation.

FIG. 6 illustrates another block diagram of a NeRF-SHL model according to an example implementation.

FIG. 7 is a sketch that illustrates raytracing to compute reflection and refraction rays according to an example implementation.

FIG. 8 pictorially illustrates a NeRF-SHL model training data capture system according to an example implementation.

FIG. 9 illustrates a block diagram of a method for synthesizing an image according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

The challenges discussed above have traditionally necessitated the use of expensive and cumbersome capture setups to obtain high-quality results, and even then, modeling of the full eye region holistically has remained elusive. The implementations described herein are related to a novel geometry and appearance representation that enables high-fidelity capture and photorealistic animation, view synthesis and relighting of the eye region using only a sparse set of lights and cameras. The hybrid representation described herein combines an explicit parametric surface model for the eyeball surface with implicit deformable volumetric representations for the periocular region and the interior of the eye.

This novel hybrid model described herein has been designed specifically to address the various parts of that exceptionally challenging facial area. In some implementations the explicit eyeball surface allows modeling refraction and high frequency specular reflection at the cornea, whereas the implicit representation is well suited to model lower frequency skin reflection via spherical harmonics and can represent non-surface structures such as hair (e.g., eyelashes, eyebrows, and the like) or highly diffuse volumetric bodies (e.g., sclera), both of which are a challenge for explicit surface models. Tightly integrating the two representations in a joint framework allows controlled photoreal image synthesis and joint optimization of both the geometry parameters of the eyeball and the implicit neural network in continuous three-dimensional (3D) space. The implementations described herein illustrate that for high-resolution close-ups of the human eye, an example model can synthesize high-fidelity animated gaze from novel views under unseen illumination conditions, allowing to generate visually rich eye imagery.

Synthesizing an image can be an element of content (e.g., a movie, AR content, VR content, and/or the like) creation. In an example implementation, the content creation includes using a model including an eye(s) (e.g., a human head, a portion of the head including the eye(s), and/or the like). A use case for generating high-resolution close-ups of the eye(s) can include zooming in on the eye(s). For example, in a first scene (e.g., a frame of the movie, AR content, VR content, and/or the like), the entire body (including the head and eyes) an avatar can be included in the scene. A display intended for viewing the content may not have a high enough resolution that necessitates a high-resolution for the eye. Therefore, existing technology may be sufficient for a content creator to use.

However, a sequence of scenes may include a zooming operation that is zooming in on the head and eyes of the avatar. Accordingly, in a second scene may include the eyes in a view that a high-resolution close-up of the is eye desired. Therefore, in the second scene, in some implementations, the hybrid model described herein may be used by the content creator to generate (or synthesize) the second (and subsequent) scene. Further, in some implementations, the gaze of the avatar can be changed in comparison to the first scene, the view of the avatar can be changed in comparison to the first scene, and/or the lighting surrounding the avatar can be changed in comparison to the first scene.

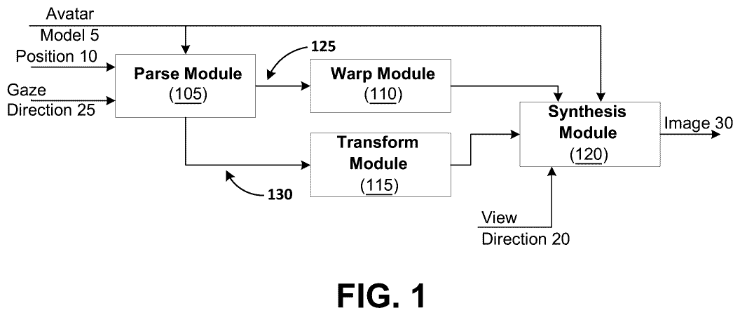

FIG. 1 illustrates a block diagram of a data flow for synthesizing an image according to an example implementation. The synthesized image can be based on content that includes at least a portion of an eye (eyeball, surface of an eyeball, portion of a surface of an eyeball, and/or the like) and the periocular region (or the region around the eye that includes skin, hair, etc.). As shown in FIG. 1, the data flow includes a parse module 105, a warp module 110, a transform module 115, and a synthesize module 120.

The parse module 105 can receive an avatar model 5, a position 10, and a gaze direction 25. The avatar model 5 can be a model (the generation of which is described below) that includes, at least, data representing (e.g., corresponding to, associated with, and the like) an eye(s) and periocular region of the avatar. In some implementations, the avatar model 5 can include data representing regions of a head outside of the periocular region (e.g., forehead, nose, hair, mouth, chin, and/or the like), a complete head, a head and neck, and so forth, including a complete avatar. The avatar model 5 can include data representing the surroundings in which a machine learned (ML) model was trained (described in detail below). The avatar model 5 can include data representing light rays directed toward the avatar. For example, the direction of light with respect to the avatar model 5 can be as though the light originates at a light source and is directed toward the avatar (e.g., the eye(s) and periocular region of the avatar). The position 10 can be an optional input. The position 10 can include data representing the location of the avatar with respect to the surroundings. The position 10 can be an optional input in, for example, a use case where the ML model was trained with the subject represented by the avatar encompassing the entirety of the surroundings. The gaze direction 25 can be a gaze direction that is different than the gaze direction that the avatar model 5 was trained.

The parse module 105 can be configured to generate data representing an eye 130 and data representing the periocular region 125 (or the region around the eye). The warp module 110 processes the data representing the periocular region 125 and the transform module 115 processes the data representing the eye 130. The synthesis module 120 can be configured to generate image 30 based on the processed data representing the periocular region 125, the processed data representing an eye 130, a view direction 20, and a gaze direction 25. As mentioned above, the gaze and view of the avatar can change. In some implementations, the gaze of the avatar can be changed in comparison to the avatar model 5 and the view of the avatar can be changed in comparison to the avatar model 5 using data (e.g., a direction) input by the content creator. Input view direction 20 and input gaze direction 25 can be the input used by the content creator to set the desired view and gaze of the avatar in the image 30.

As an example, in a content creation application (e.g., software) an image 30 can be created using the dataflow of FIG. 1. In this example, the image 30 can be a content to be included in a frame of a video (e.g., an avatar), a portion of a frame of a video (e.g., including the avatar), a frame of video (e.g., including the avatar), an image to be used in an AR/VR/MR content, and/or the like. The avatar model 5 can be a 3D mesh or a 3D mesh can be generated based on the avatar model 5. In an example implementation, the parse module 105 can be configured to receive the avatar model 5 and to generate the 3D mesh based on the avatar model 5. Alternatively (or in addition), the parse module 105 can receive the 3D mesh as generated based on the avatar model 5 by a separate component of the content creation application. The parse module 105 can be further configured to identify an eye in the 3D mesh, select a first point (3D mesh point) based on the identified eye, and select a second point (3D mesh point) based on the identified eye. In some implementations, the avatar model 5 can be a trained neural network that includes both the appearance and motion of an evaluated subject and encoded and/or encapsulated in neural network weights. Further, the parse module 105 can be configured to select the points freely chosen in space, some points being within the eyeball and some outside of the eyeball.

For example, the first point can be data representing the eye 130 and the second point can be data representing the periocular region 125. Then, the first point can be transformed, and the second point warped. Transforming and warping is described in more detail below. The synthesis module 120 can generate an image point (e.g., a data point in a RGB format) based on the first and second points (e.g., transformed first point and the warped second point). For example, an opacity, an albedo, and spherical harmonics (SH) coefficients can be generated based on the transformed first point and the warped second point. Opacity is a lack of transparency (or the opposite of transparent where the larger the opacity the less transparent), albedo is the proportion of the incident light that is reflected by a surface, and spherical harmonic coefficient are based on an integral over an entire sphere of the density function times a fixed harmonic function. Finally, the image point based on the albedo, and the SH coefficients. This dataflow can be performed on a plurality of first and second points of the 3D mesh and the image 30 can be generated (e.g., rendered) based on a plurality of (e.g., stored or queued) image points.

For example, eyes provide not only important social cues, but are overwhelmingly interpreted as diagnostic of the subject's emotional state even in presence of competing signals from the lower face. Thus, it is only natural that as the graphics community embarks on another wave of photorealistic 3D avatar technologies, sufficient attention is paid to the development of methods and systems that allow for fine-grained photorealistic control over human eye imagery. Therefore, example implementations can include periocular region modifications (e.g., warping) that can show social cues, emotional state, and the like.

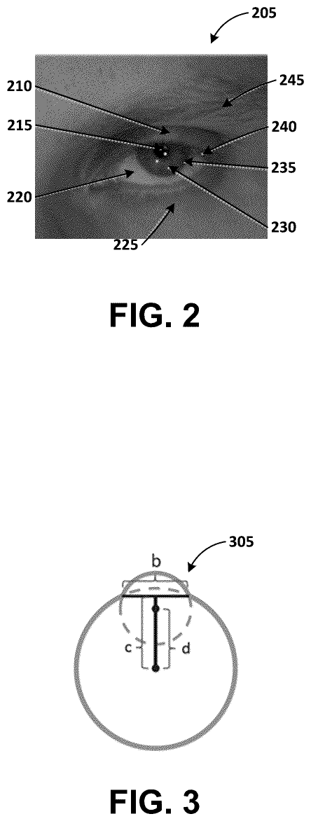

Modeling the eye region is challenging due to its complex anatomy. FIG. 2 illustrates a portion of a human face 205 including an eye and a periocular region according to an example implementation. The eyeball and the periocular region exhibit very different geometry, motion and appearance characteristics. The eyeball is rigid, rotating, and reflective/refractive, whereas the surrounding region is non-rigid, smoothly deforming and light-scattering. Hence, we use different representations to model each of these parts. The eyeball is a nearly smooth and rigid spheroid, which experiences negligible deformation. The eye's outer surface 220 (e.g., the sclera or eye white) consists of a thin clear layer which is highly reflective. The eye's inner surface includes the iris 230, the cornea 235, and the pupil 215. The inner surface includes a corneal bulge which is the protruding center that allows light to enter the eye. The cornea 235 refracts light rays into the eyeball, which are further concentrated by the iris 230 sphincter into the pupil 215. On the other hand, the periocular region or surrounding region of the eye consists of multiple non-rigid and deforming materials like periorbital skin 225, eyelid 210, eyelashes 240, and eyebrows 245 with fine geometry that exhibit light scattering effects. The motion of the eyeball is controlled by extraocular muscles that allow for fast rotation, while the periorbital skin 225 (e.g., the skin surrounding the eye) exhibits smooth nonlinear deformation.

Existing techniques do not reconstruct the periocular region including the eyelid 210, eyelashes 240, eyebrows 245, and periorbital skin 225, which are key to capturing eye expressions such as squinting, drooping, widening, and the like. For example, existing techniques cannot model fine structures of eyebrows 245 and eyelashes 240 and the existing techniques require a dense multi-view capture setup to reconstruct a mesh representing an image in a pre-processing step. Existing techniques do not disentangle the complex reflectance of the eye and skin from the scene illumination, which make the existing techniques unsuitable for the applications of high-quality image synthesis under desired lighting environments. Further, some existing techniques are not animatable and do not provide a solution to modeling surface reflectance and high-frequency light-transport effects such as corneal light reflection and refraction associated with the eye, which prohibits relighting.

Example implementations include a novel hybrid representation that combines the best of mesh based and volumetric reconstruction to achieve animatable synthesis of the eye region under desired environmental lighting. The implementations described herein use a light-weight capture system consisting of a small number of static cameras and lights along with a single hand-held camera with a co-located light source.

The implementations described herein model the eyeball surface as an explicit mesh and the canonical shape of the periocular skin region and the interior eye volume using an implicit volumetric representation. In some implementations described herein, the eyeball mesh is used to explicitly compute specular reflections of light rays as well as refraction of the camera rays at the cornea surface. In some implementations described herein, the deformations of the surrounding skin and hair is computed using a learnt warp field over the canonical volume. In order to achieve relightability, some implementations described herein learn the underlying reflectance represented by spherical harmonics coefficients. In some implementations described herein, the outgoing radiance is then computed as a product of the reflectance and environmental illumination in the 3D frequency domain.

Some implementations described herein jointly optimize for the shape and pose of the eyeball mesh and the density and reflectance in the implicit volume, supervised to minimize the photometric loss between the modeled outgoing radiance and pixel values in the captured video. The methods described herein are able to successfully reconstruct the canonical geometry of the eye region and model it's appearance by accurately disentangling shading from diffuse and specular albedos. This enables photorealistic view synthesis and relighting by recomputing the shading under novel environmental illumination.

Moreover, by interpolating between the learnt warp field of the captured frames and rotating the explicit eyeball mesh, some implementations described herein achieve fine-grained control over the subject's gaze. At least some features can include a hybrid mesh+implicit volumetric representation that allows for modeling of complex reflectance and fine scale geometry of the eye region, a capture system using only off-the-shelf hardware that allows capturing data to disentangle appearance from scene illumination to achieve high-frequency relighting, and some implementations described herein illustrate exciting animated and relit results on several real subjects with varying facial and ocular characteristics.

Automatic reconstruction of the human eye and face involves complex modeling of geometry, appearance, and deformation. The implementations described herein take explicit eyeball modeling methods for the eyeball surface, the deformable volumetric reconstruction for the periocular region and the volumetric relighting techniques to disentangle reflectance from environmental lighting using a sparse multi-view capture setup including a single handheld freely-moving camera with a co-located light source, and a lighting visibility model which avoids expensive secondary reflection rays by approximating self-occlusion using a neural network.

The eye region includes elements with different visual properties. The surface of the eye is specular, and it mirrors the environment overlaid over the underlying iris, which is heavily distorted through the optical refraction at the corneal surface, especially for side-views. The white sclera is highly scattering, exhibiting veins at different depths inside. The eye is embedded in the periocular region, further adding to the challenge as it combines highly deforming skin and hair from lashes and brows. To address this large diversity, the implementations described herein include a novel hybrid model that combines the strengths of explicit and implicit representations. In this section the individual parts of the model and how they fit together are described.

FIG. 3 illustrates an eye model according to an example implementation. The eye model 305 can be an explicit eyeball surface model. In some implementations described herein, to model the highly reflective and refractive eyeball surface the implementations herein represent the eyeball surface with an explicit parametric shape model. The implementations described herein employ a variant of an eye model, which includes two overlapping spheres, but other parametric models could be used as well.

The model is fully parameterized by 3 parameters: iris radius b, which specifies the width of the intersecting circle of the eyeball and cornea spheres, the iris offset c which specifies the distance of the aforementioned circle from the eyeball center, and the cornea offset d, which specifies the relative distance of the two sphere centers. These values can then be used to derive the main eyeball radius as well as the cornea radius.

The implementations herein blend the eyeball and corneal sphere at the transition (limbus). This blending is controlled by two additional learnable parameters, determining where the transitions on the eyeball and corneal spheres start. The model is discretized as a triangular mesh with V vertices (e.g., 10242 vertices), and enriched with per-vertex displacements, which enable the surface to represent shapes that lie outside the model's subspace. The implementations herein compute the shading normals at each vertex (used for refraction and reflection) by interpolating between the neighboring face normals weighted by their vertex angle. For the index of refraction (IOR), the implementations can use, for example, the value of 1.4, which is a reasonable value for the human cornea. While the implementations herein assume the eyeball surface to remain static for a subject, its pose changes as a function of gaze. Though eye gaze is often modeled as a 2-DoF rotation only, it is actually more complex than that and hence the implementations herein model its motion by a 6-DoF transformation per frame, encoded in axis angle representation, with translation being applied after rotation.

In some implementations described herein, the periocular region can be modeled using an implicit eye interior and periocular model. The highly scattering sclera, the volumetric iris, the transition between eyelid and eye, and especially hair fibers present a formidable challenge for explicit models, and so an implicit representation is better suited to represent the periocular region. The modeled periocular region can be merged or integrated with the eye. Since the skin deforms during acquisition the representations herein are based on Nerfies, which employ warp fields to transform frames into a common canonical space, where a multi-layer perceptron (MLP) network encodes opacity and appearance values. The warp field is defined by a secondary MLP which predicts a rotation quaternion and translation vector. The implementations herein combine the smooth warp field proposed by Nerfies with the rigid transformation from the eyeball surface to explicitly transport rays to a canonical eye volume once they intersect the eyeball surface, where the NeRF encodes the interior.

To enable relighting the implementations herein are directed to a NeRF with Spherical Harmonics Lighting (NeRF-SHL), which extends the traditional NeRF network to additionally predict spherical harmonics coefficients alongside opacity and albedo. In some implementations described herein, these coefficients are used to predict the exiting radiance given an environment map and implicitly approximate various light-transport effects, including reflectance, subsurface scattering, occlusion, and indirect illumination. In some implementations described herein, to model the combination of diffuse and specular reflectance, two sets of spherical harmonics (SH) coefficients can be predicted using 5th order SH for the diffuse and 8th order SH for the specular reflectance.

In an example implementation, for every 3D point in world space and a view direction, the hybrid model is trained to output the corresponding RGB color and opacity value. The 3D world-space point is first transformed to the canonical NeRF space by using the learned per frame rigid eyeball transformation or warp field, depending on whether the point lies inside the eyeball. Next, NeRF-SHL is evaluated to obtain the opacity, the albedo, and specular and diffuse spherical harmonics (SH) coefficients. The SH coefficients are multiplied with the pre-computed SH representation of the environment map and composited with the albedo to obtain the final RGB color for the 3D point. In some implementations described herein, as diffuse reflectance is constant with regards to the outgoing light direction, only the specular SH coefficients are conditioned on the view direction. The network takes as input a 3D World-Space point and its corresponding 3D NeRF-Space point alongside their positional encodings as well as the view direction and outputs diffuse and specular spherical harmonics coefficients for the query point.

These are integrated with the environment illumination and combined to produce the RGB value. As in the original NeRF network, the implementations herein constrain the opacity to be positive using a ReLU activation, and apply a sigmoid to the albedo, similar to how the RGB is constrained in the original network.

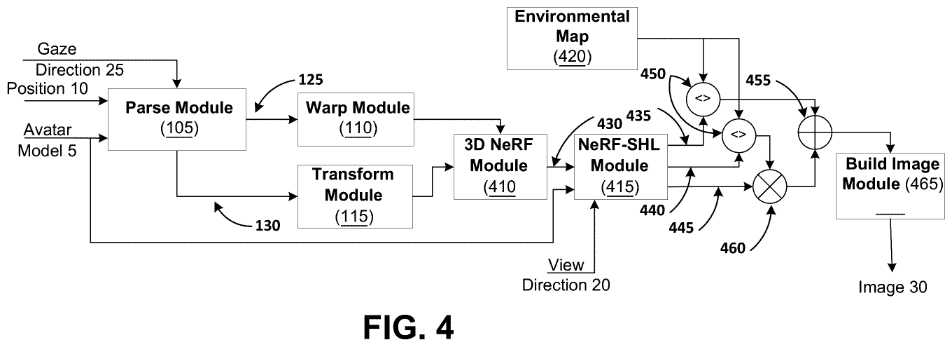

FIG. 4 illustrates a block diagram of a data flow for synthesizing an image according to an example implementation. As shown in FIG. 4, the dataflow includes the parse module 105, the warp module 110, the transform module 115, a 3D NeRF module 410, a NeRF-SHL module 415, an environmental map 420, and a build image module 465. As mentioned above, the dataflow operates on a point basis. Therefore, the parse module 105 can receive the avatar model 5 and generate (identify, select, etc.) data, as a point having cartesian coordinates, representing an eye 130 and data, as a point having cartesian coordinates, representing the periocular region 125 (or the region around the eye).

The warp module 110 can be configured to use warp fields to transform the 3D world-space point into a common canonical space, where a multi-layer perceptron (MLP) network encodes opacity and appearance values. The warp field is defined by a secondary MLP which predicts a rotation quaternion and translation vector. The transform module 115 can be configured to transform the 3D world-space point to the canonical NeRF space by using the learned per-frame rigid eyeball transformation. In some implementations, the avatar model 5 can be a trained neural network that includes both the appearance and motion of an evaluated subject and encoded and/or encapsulated in neural network weights. The avatar model 5 can be evaluated by the warp module 115 and the NeRF-SHL module 415. Further, the parse module 105 can be configured to select the points freely chosen in space, some points being within the eyeball and some outside of the eyeball.

The 3D NeRF module 410 can be configured to generate a 3D NeRF-space point 430 based on the canonical NeRF space points output by the warp module 110 and the transform module 115. The NeRF-SHL module 415 can be configured to generate diffuse and specular spherical harmonics coefficients for the query point based on a 3D World-Space point and its corresponding 3D NeRF-Space point 430 alongside their positional encodings as well as the view direction based on the 3D NeRF-Space point 430, the view direction 20, and the avatar model 5. The specular spherical harmonics coefficients specular SH coefficients 435 and diffuse SH coefficients 440. The NeRF-SHL module 415 can be further configured to generate an albedo 445 (e.g., reflections from a surface). The environmental map 420 can be used for environmental relighting. In other words, the environmental map 420 can be used to change an image's environmental lighting.

In an example implementation, an RGB pixel can be generated by taking a dot product +ReLU 450 of the specular SH coefficients 435 and the environmental map 420, taking a dot product+ReLU 450 of the diffuse SH coefficients 440 and the environmental map 420, taking an elementwise product 460 of the albedo 445 and the diffuse SH coefficients 440 dot product, then adding the elementwise product 460 with the specular SH coefficients 435 dot product. The build image module 465 can be configured to generate the image 30 based on a plurality of RGB pixels.

In the example implementation described above, the dataflow is used by a content creator. However, the dataflow can be implemented in other devices. For example, the dataflow can be performed in a video conference device. For example, in a first or sending device a video of a user and a video of the surroundings can be captured. Then the avatar model 5 can be generated as a 3D mesh based on each frame of the video of the user. In addition, the environmental map 420 can be generated as a 3D mesh based on each frame of the video of the surroundings. The dataflow continues as described above except the 3D NeRF-space point 430 is accumulated for each frame and communicated (e.g., via the Internet) together with the environmental map 420 to a second or receiving device. The second receiving device can also capture video of a user and a video of the surroundings. The environmental map 420, the view direction 20 and the gaze direction 25 can be determined based on the video of the user and the surroundings. Image 30 is then generated and rendered as a frame of the video conference on the second or receiving device.

In another example, the dataflow can be performed in a wearable device (e.g., smartglasses, a head mounted display, and AR/VR/MR device, and/or the like) including a display (e.g., a 3D display). For example, as AR/VR/MR content the avatar model 5, the environmental map 420, and optionally the position 10 can be input as an operation of an AR/VR/MR application. The dataflow continues as described above except, the environmental map 420, the view direction 20 and the gaze direction 25 can be determined by the wearable device using components (e.g., cameras, IMU, and the like). Image 30 is then generated and rendered as a frame of the AR/VR/MR content on the display of the wearable device.

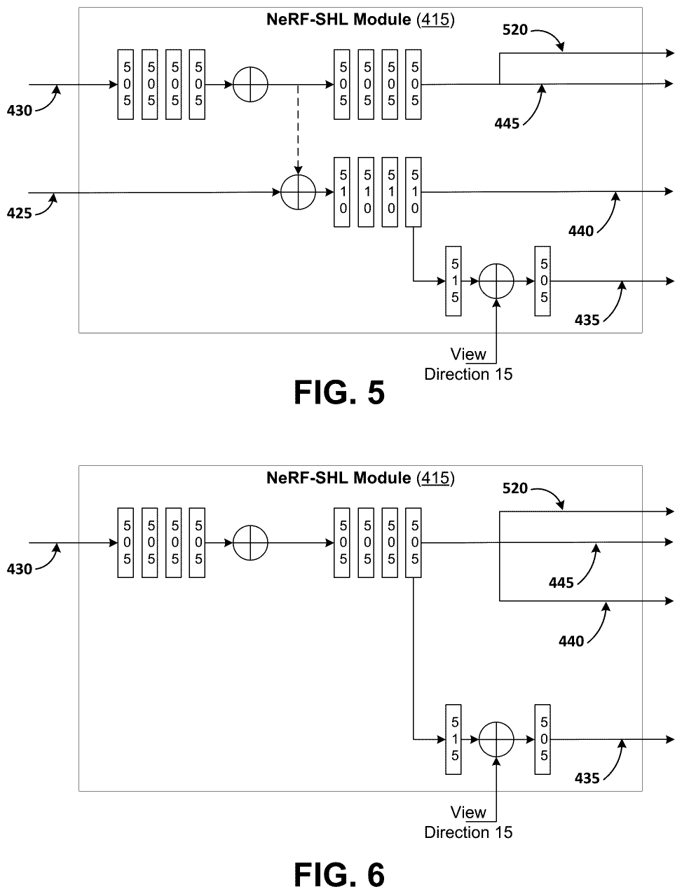

Additionally, the implementations herein can be configured to apply a softplus activation function to the 0th degree spherical harmonics function to force it to be positive, as that particular spherical harmonic corresponds to the uniform function which needs to be positive for any physically correct light transport function. FIG. 5 illustrates a block diagram of a Neural Radiance Fields (NeRF) with Spherical Harmonics Lighting (SHL) model according to an example implementation. The architecture for NeRF-SHL can be divided into three branches. The first branch (e.g., using concatenation) predicts opacity 520 and albedo 445 from the 3D point in canonical NeRF space. For the second branch, the 3D world-space point is additional fed (e.g., concatenation) as input to generate the diffuse SH coefficients 440 with better model shadowing. Lastly, the view direction is added as input for the branch that predicts specular SH coefficients 435. The neural network uses a dense layer with ReLU 505, 510 blocks and a dense layer without ReLU 515 blocks. In an example implementation, the dense layer with ReLU 505 uses a batch size of 256 and the dense layer with ReLU 510 uses a batch size of 128.

In some implementations described herein, environmental illumination is represented as a latitude-longitude environment map E ωi, which determines the amount of radiance entering the scene from a direction ωi. While relighting the explicit eyeball surface can consume the environment map directly, it can be converted to a spherical harmonics representation for relighting the implicit parts of the model to be compatible with the network architecture shown in FIG. 4.

The implementation herein includes a spherical harmonics precomputation which starts with the standard light transport equation (without emission), at any given point x and outgoing light direction (or camera direction):

Lₒ(x,ωₒ)=∫_{Ω}f(x,ωₒ,ωᵢ)Lᵢ(x,ωᵢ)dωᵢ (1)

In the model, Li includes all incident light at position x, i.e., light from both direct and indirect light as well as incident illumination from subsurface scattering, and hence f approximates the full light transport at x for the entire sphere Ω. This equation can be reformulated to instead determine the amount of light transported from the environment map E via a point x towards ωo as:

Lₒ(x,ωₒ)=∫_{Ω}fₜₒₜ(x,ωₒ,ωᵢ)E(ωᵢ)dωᵢ (2)

While intractable with traditional computer graphics methods, it is possible to approximate ftot using machine learning techniques. In some implementations described herein, ftot can be approximated using the spherical harmonics basis functions Ylm and their corresponding coefficients clm:

$${f}_{tot ( x , {ω}_{o} , {ω}_{i} )} \approx {\sum }_{l = 0}^{order} {\sum }_{m = - l}^{l} {c}_{lm} ( x , {ω}_{o} ) {Y}_{lm} ( {ω}_{i} ) , \qquad ( 3 )$$

resulting in the following approximation:

$${L}_{o} ( x , {ω}_{o} ) \approx {\int }_{Ω} {\sum }_{l = 0}^{order} {\sum }_{m = - l}^{l} {c}_{lm} ( x , {ω}_{o} ) {Y}_{lm} ( {ω}_{i} ) E ( {ω}_{i} ) d {ω}_{i} . \qquad ( 4 )$$

By using associativity of sums and integrals as well as distributivity of sums and products, Eq. 4 can be reordered such that the integral can be precomputed independently of the coefficients:

$${L}_{o} ( x , {ω}_{o} ) \approx {\sum }_{l = 0}^{order} {\sum }_{m = - l}^{l} {c}_{lm} ( x , {ω}_{o} ) ( {\int }_{Ω} {Y}_{lm} ( {ω}_{i} ) E ( {ω}_{i} ) d {ω}_{i} ) . \qquad ( 5 )$$

Most notably, the integral is now independent of the conditioning variables, x and coo, which allows to compute the integral once for each spherical harmonics order and degree for a given environment map, making model training tractable. As described in below subjects can be captured under a mixture of static environment illumination and a moving point light and precompute a spherical harmonics representation for both. These representations can be rotated appropriately to compensate for head-rotation, which can be done efficiently. Lastly, the SH coefficients of the moving light are scaled as a function of the distance to the subject to account for squared intensity falloff and the two sets of coefficients are summed to allow relighting of our implicit model.

In some implementations described herein, the presented model can be evaluated for a desired gaze direction and rendered from novel viewpoints under novel illumination. The above models can be trained on a diverse set of discrete gaze directions, some implementations described herein allow continuous reanimation of the eye and surrounding region by interpolating the deformation fields and eyeball poses of the discrete training data. In some implementations described herein, given a novel gaze direction γ the first step is to identify three gaze directions \hat{γ}ᵢ which form a convex hull that contains the target gaze direction. In some implementations described herein, for this, all training gaze directions are projected onto the unit sphere by applying their respective rigid eyeball transforms to the unit vector (0, 0, 1)^{T} and triangulate those points using the Ball-pivoting Algorithm to obtain a discrete mesh.

The intersection of the target gaze direction γ can be computed with this mesh. In some implementations described herein, the vertices of the intersected triangle are the desired discrete gazes γ\hat{ }i, and the barycentric weights of the intersection point serve as interpolation weights which are then used to blend the warp fields of the three sample gaze directions by linearly interpolating between the warped points.

For the eyeball transformation, some implementations described herein consider the translation and rotation components separately. In some implementations described herein, the translation is interpolated using barycentric weights as done for the warp field. The rotation on the other hand is more challenging, since the basic spherical linear interpolation (slerp) leads to unnatural eye motion. Instead, some implementations described herein independently rotate the eyeball for each sample gaze to the target gaze, and slerp the resulting poses sequentially. In some implementations described herein, this yields satisfactory eye motion, but more advanced eye rigging methods, such as a listings model used in, could also be integrated with the proposed hybrid model.

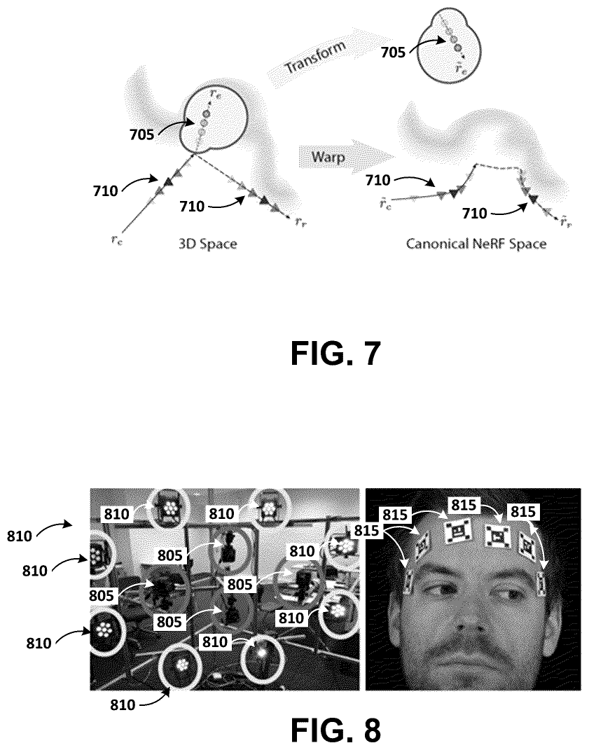

Once the interpolated warp field and rigid transformation have been computed, one objective can be to render an image for a given camera and environmental illumination. FIG. 7 is a sketch that illustrates raytracing to compute reflection and refraction rays according to an example implementation. As shown in FIG. 7, the implementations described herein use raytracing to compute reflection rᵣ and refraction rₑ rays by intersecting with the explicit eyeball surface. Those rays are then used to raymarch the implicit representation. Points are sampled in 3D space, and then transformed to the canonical NeRF Space. Points sampled from the refraction ray rₑ are transformed rigidly by the inverse estimated eyeball pose, circles 705, where points sampled from the other rays are warped non-rigidly by the learned warp field triangles 710.

For each pixel in the image some implementations described herein compute the camera ray r_{c} and trace it through the scene within appropriate clipping planes. Some implementations described herein start by testing if the ray intersects with the explicit eyeball surface using Trimesh, a raytracer implemented using Embree. In case there is an intersection, some implementations described herein calculate appropriate reflection and refraction rays at the corneal surface using Snell's law, splitting the original ray into three parts: The pre-intersect ray r_{c}, the refracted ray re, and the reflected ray rᵣ. If there is no intersection, some implementations described herein consider the pre-intersect ray r_{c}.

Referring to FIG. 4 and FIG. 7, some implementations described herein sample points along the three rays and transform them to the canonical NeRF volume. Some implementations described herein employ a combination of equidistant and importance sampling in 3D world-space to determine the sample points. For each sample point of the pre-intersect and reflected rays, some implementations described herein evaluate the warp field neural network and warp the points, leading to sample points along the distorted rays \tilde{r}_{c} and \tilde{r}ᵣ in the canonical 3D NeRF-space (the learned warp field triangles 710 in FIG. 7). For each sample point on the refracted ray, some implementations described herein apply the inverse of the rigid eyeball transform leading to sample points in the canonical 3D NeRF-space of the eye (circles 705 in FIG. 7).

Next, some implementations described herein calculate the contribution of the illumination from the environment map for each sample point. Some implementations described herein then query NeRF-SHL to obtain albedo and opacity, as well as specular and diffuse SH coefficients that determine the amount of light transported from the environment map at the queried volume point towards the queried camera ray direction. Incident illumination and transfer function are integrated by multiplying the SH coefficients with the precomputed SH environment coefficients, which is very efficient. The final color value for the sample point is then obtained by multiplying the diffuse lighting with the albedo and adding the specular lighting. For the end point of each ray, i.e., when it is leaving the captured volume, some implementations described herein add one sample point with infinite opacity and a color value. For reflection rays the color is retrieved from the environment map and for the other rays it is set to black. To account for ambiguities in scale when reconstructing the environment map using the mirror ball, some implementations described herein also learn a scale factor which is multiplied with the environment map radiance sample.

The previous step provided opacity and color for each of the N_{S} sample points independently. To obtain the contribution weight of each sample to the final color value, some implementations described herein employ traditional volume rendering techniques. To this end, some implementations described herein calculate the accumulated transmittance for each sample point based on the opacity of all previous samples on the ray. In the traditional NeRF setting, the color value of a single ray C(r) is computed using the following approximation of the continuous integral along the ray

$${α}_{i} = {e}^{- {σ}_{i} {δ}_{i}} {T}_{i} = {\prod }_{i = 0}^{t - 1} {α}_{i} C ( r ) = {\sum }_{t = 0}^{{N}_{S}} {T}_{t} ( 1 - {α}_{t} ) {c}_{t} \qquad ( 6 )$$

where σi and ci are the predicted opacity and color for the i-th sample, respectively, and δi represents the distance between the i-th and i 1-th sample.

Some implementations described herein first compute the color value of the reflected ray separately, and then merge the refracted and pre-intersect ray using the Fresnel Equations (assuming unpolarized light), by combining the radiance of the reflected ray with the last sample prior to the intersection using standard alpha compositing rules, effectively placing it behind that sample. Some implementations described herein can then treat the resulting combined samples as one ray, resulting in the following system of equations

$${α}_{i}^{′} = {e}^{- {σ}_{i}^{′} {δ}_{i}^{′}} {T}_{t}^{′} = {\prod }_{i = 0}^{t - 1} {α}_{i}^{′} C ( {r}^{′} ) = {\sum }_{t = 0}^{{N}_{S}^{′}} {T}_{t}^{′} ( 1 - {α}_{i}^{′} ) {c}_{i}^{′} \\ {α}_{comb} = {α}_{k} ( 1 - f ) {c}_{comb} = \frac{( 1 - {α}_{k} ) {c}_{k} + f {α}_{k} C ( {r}^{′} )}{{α}_{comb}} \\ {c}_{i}^{″} = \{ \begin{matrix}{c}_{i} & i \neq k \\ {c}_{comb} & i = k\end{matrix} {α}_{i}^{″} = \{ \begin{matrix}{α}_{i} & i \neq k \\ {α}_{comb} & i = k\end{matrix} \\ {α}_{i} = {e}^{- {σ}_{i} {δ}_{i}} {T}_{t} = {\prod }_{i = 0}^{t - 1} {α}_{i} C ( r ) = {\sum }_{t = 0}^{{N}_{S}} {T}_{t} ( 1 - {α}_{t}^{″} ) {c}_{t}^{″} \qquad ( 7 )$$

where f is the Fresnel factor, k is the index of the last sample prior to the intersection, α′, etc. refer to values sampled along the reflected ray, and ci″ refers to the samples of the combined ray (which are the same as the ones along the pre-intersect and refracted ray, other than the sample prior to the eyeball intersection). Rays that do not intersect the eye model are computed using the original NeRF ray marching method (see Eq. 6).

High quality synthesis can require high-quality data. For example, high quality synthesis can require high-quality data to train an ML model associated with an avatar module and/or models associated with synthesis. While there are several publicly available eye image datasets, they are unfortunately not directly suited for purposes of view, gaze, and illumination synthesis. The majority of these datasets can be tailored for the task of gaze-tracking while others cater to different problems such as pupil detection, eye closure detection or eyelash segmentation. While there are datasets that aim at modeling high-quality eyes and periocular region, these are not suited for relighting purposes.

Accordingly, a capture system that provides sufficient signal for the task of gaze reanimation, view synthesis and relighting of the periocular region can be built. FIG. 8 pictorially illustrates a NeRF-SHL model training data capture system according to an example implementation. NeRF-SHL model training data capture system can be used to capture data used to train models (e.g., models including neural networks having blocks 505, 510, 515).

Some implementations described herein aim to minimize hardware complexity to make the solution cost and space effective. The subject sits on a chair in the center of the setup shown in FIG. 8. The setup includes N, for example 4, high-quality cameras 805 arranged in a diamond-shape and surrounded by M, for example 8, illuminators 810 where M is greater than N. A set of AR markers 815 is attached to the forehead of the subject to track head movement as well as relative camera motion. For example, the multi-view setup consists of N high quality, hardware synchronized cameras fixed in the frontal hemisphere of the subject, as well as a small, lower quality mobile camera which is moved freely by hand by the operator. A moving camera can include a co-located LED light, which is for relighting. The subject is lit with 8 white LED point lights that are nearly uniformly located over, for example, a 100° field-of-view (FOV) in front of the subject. The cameras span roughly, for example, 75° horizontal FOV and 25° vertical FOV in front of the subject, arranged in a diamond shape.

In order to account for the free head motion of the subject, some implementations described herein affix a set of small calibration markers on their forehead. These calibration markers are used to localize both the subject's head and the moving camera with respect to the static setup. While some implementations described herein assume that the eyeball is rigidly attached to the head, some methods make no such assumption for the periocular region which can experience strong deformations due to facial muscles and skin.

Some implementations described herein capture subjects under, for example, four different conditions. In the first condition, the subject can be instructed to follow the mobile camera with their gaze while keeping their head static and forward facing. The mobile camera can be translated freely, while orienting it towards the subject's head, covering about 60° horizontally and 30° vertically.

In this setting, some implementations described herein only use the M static lights. Since the eye gaze follows the mobile camera, the gaze direction is known and a good multi-view coverage of the eye from the N static cameras is obtained. In the other three conditions, the subject is instructed to keep their gaze focused on one of the four static cameras, switching their gaze between them when instructed. Instead of moving their gaze, they are instructed to rotate their head around, while attempting to keep one eye roughly stationary, to keep that eye in frame and at the same distance from the cameras. In order to keep track of where that eye is, a tripod can be placed below the subject's head for reference (not as chin rest). In these settings, good viewpoint coverage of the periocular region from the N cameras can be obtained.

Each of these three conditions models a different illumination scenario; static lights, mobile light, and both. This provides a good mixture of frames where some implementations described herein have relatively flat lighting which is useful for reconstructing the geometry, and very high frequency lighting which can be used to learn shading and shadowing.

Intrinsics for at least some (e.g., all) cameras are calibrated using a from the same calibration process. The extrinsics of the mobile camera are estimated from the marker tags on the subject's forehead using OpenCV. By also estimating the rigid transformation between the static cameras and the subject some implementations described herein can relate all cameras into the same world frame, registered to the subject's head.

Some implementations described herein an HDR environment map (e.g., environmental map 420) can be computed from a series of images from a mirror sphere with varying exposure. Some implementations described herein capture an environment map for the static illumination and the mobile light separately. Both the mobile and static lights are captured only once; some implementations described herein model the light motion using rotation and falloff as described above.

In some implementations described herein, the method relies on an initial estimate of the eyeball pose and shape. As the subject is instructed to look at either the mobile camera or one of the static cameras, the initial eye pose can be estimated from the line-of-sight that connects the eyeball and camera centers. Some implementations described herein manually initialize eyeball pose and shape from three frames, roughly placing the eyeball in the correct position and shape in a 3D modeling software (Blender).

As the main training loss, some implementations described herein use the mean squared error in sRGB space between the equidistant and importance sampled RGB values and the target pixel in the training image. The loss is computed on the outputs of the coarse and fine network

lᵢₘ=∥srgb(x′)−srgb(x_{f})∥₂²+∥srgb(x′),srgb(x_{c})∥₂² (8)

As the sRGB transformation may not be meaningful above, some implementations described herein use a linear transformation for such values. To encourage the hybrid model to represent specular reflection on the sclera by the explicit eyeball model, some implementations described herein ignore sclera pixels above a defined threshold when training the implicit volume.

In addition, some implementations described herein employ the non-negative SH loss for regularization. Each iteration, some implementations described herein randomly sample ten random directions, check if there are any negative predicted SH response functions, and then apply an l₂ loss on negative values. This avoids dead zones if the SH becomes negative. Furthermore, some implementations described herein observe that the diffuse shading is almost never non-positive anyway, and only apply this loss to the specular part of the shading. In order to reduce the uncertainty between diffuse and specular shading, some implementations described herein furthermore apply an l₂ loss to the specular coefficients. These losses are applied to the mean across all sample points.

$${l}_{noneg} = {𝔼}_{{ω}_{i} ∼ Ω} [ - min ( 0 , {\sum }_{l = 0}^{order} {\sum }_{m = - l}^{l} {c}_{lm} ( x , {ω}_{o} ) {Y}_{lm} ( {ω}_{i} ) ) ] \\ {l}_{spec} = \frac{1}{{( order + 1 )}^{2}} {\sum }_{l = 0}^{order} {\sum }_{m = - l}^{l} {‖ {c}_{lm} ( x , {ω}_{o} ) ‖}_{2}^{2} \qquad ( 9 )$$

Some implementations described herein then apply an L2 loss on the per-vertex offsets (NV=10242), to avoid strong deviations from the underlying analytical model

$${l}_{off} = {\sum }_{i = 0}^{{N}_{V}} {offset}_{i}^{2} , \qquad ( 10 )$$

Finally, some implementations described herein apply the same elastic regularization as used by Nerfies onto the warp field. Some implementations described herein refer the reader to their paper on more details on how this loss term is computed. This results in the final loss function tot:

lₜₒₜ+λᵢₘlᵢₘ+λ_{noneg}l_{noneg}+λ_{spec}l_{spec}+λ_{elastic}l_{elastic}+λ_{off}l_{off} (11)

where the empirically chosen weights λim=1, λnoneg=1e-2, λspec=5e-4, λelastic=1e-3, λoff=1e-6 are used.

Some implementations described herein are trained in three stages, using slightly different architectures, on a total of, for example, 16 GPUs. First, some implementations described herein use the simplified architecture for our NeRF-SHL as shown in FIG. 6 to focus on learning the eyeball model parameters and per-frame rigid transformations. FIG. 6 illustrates another block diagram of a NeRF-SHL model according to an example implementation. To improve initial network convergence, some implementations described herein start training with the simplified architecture shown above, and later on continue to train the full architecture as depicted in FIG. 5. The main difference is that here the diffuse SH coefficients only depend on the 3D NeRF-Space points, whereas in the full model they also depend on the 3D World-Space points, in order to better model shadowing.

During this stage, every, for example 50000 iterations, some implementations described herein additionally reset and reinitialize all learnable parameters other than the ones for our parametric model. Some implementations described herein observe that this re-initialization greatly improves the final quality. This is due to two reasons. On the one hand, every time the volume is reinitialized, all possible biases that may have been baked into the eyeball volume may be removed, for example due to view dependent effects. On the other hand, by resetting the volume we effectively blur it out, making the spatial gradients much smoother and therefore easier to learn with. For better signal when optimizing the eyeball pose and shape, some implementations described herein do not ignore the sclera pixels during this stage. This takes a total of approximately three days when trained on 8 of the 16 GPUs.

Second, some implementations described herein start training with the main NeRF-SHL architecture as shown in FIG. 5 to obtain initial network weights (for the warp field network and the NeRF-SHL network) helping robustness of the third step. Note that this second step can take place in parallel with the first as they do not depend on each other, and also takes approximately three days, using the other 8 GPUs. Third, once the eyeball model parameters and transformations have converged, some implementations described herein load them into the main architecture and continue training for roughly 100,000 iterations.

During this final training stage, some implementations described herein disconnect the dotted connection in FIG. 5 for points inside the eyeball by conditionally zeroing those values, to stronger condition the estimated SH lighting contribution on the world space points. Some implementations described herein also disable the contribution from the specular shading, in order to encourage the network to model as much as possible using direct reflections.

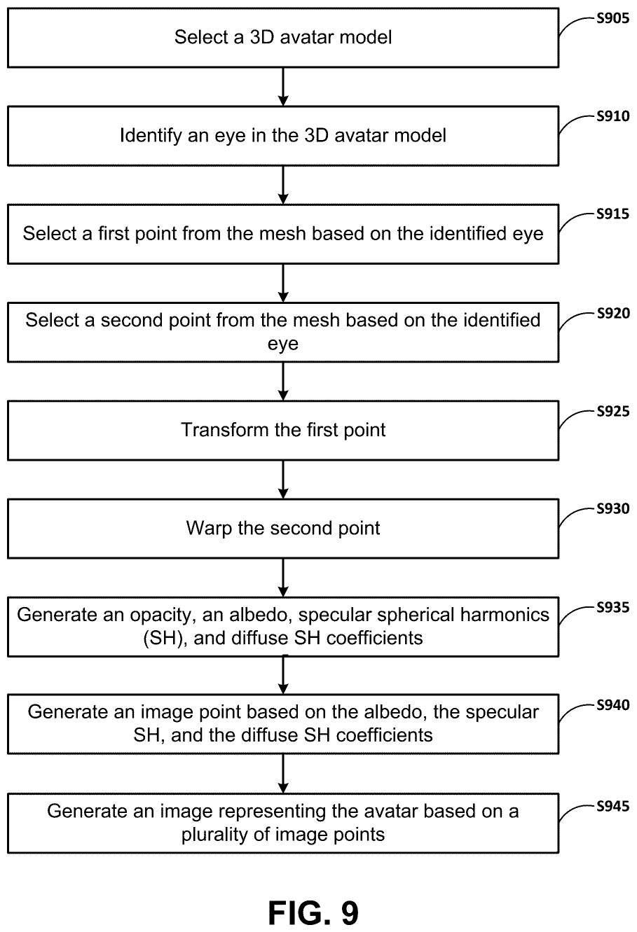

Example 1. FIG. 9 is a block diagram of a method for synthesizing an image according to an example implementation. As shown in FIG. 9, in step S905 a 3D avatar model is selected. In step S910 an eye is identified in the 3D avatar model. In step S915 a first point is selected from the 3D model based on the identified eye. In step S920 a second point is selected from the 3D model based on the identified eye. In step S925 the first point is transformed. In step S930 the second point is warped. In step S935 an albedo and spherical harmonics (SH) coefficients are generated based on the transformed first point and the warped second point. In step S940 an image point is generated based on the albedo and the SH coefficients. In step S945 an image representing the avatar is generated based on a plurality of image points.

Example 2. The method of Example 1 can further include storing a plurality of image points using the generated image point and generating an image representing the avatar based on a plurality of image points.

Example 3. The method of example 2, wherein the generating of the image representing the avatar can include rendering the image representing the avatar using raytracing to compute reflection rays and refraction rays.

Example 4. The method of example 1, wherein the SH coefficients can include specular SH coefficients and diffuse SH coefficients.

Example 5. The method of example 1, wherein the transforming of the first point can include explicit modelling of a surface of the eye.

Example 6. The method of example 1, wherein the warping of the second point can include generating a deformable volumetric reconstruction for a periocular region associated with the eye.

Example 7. The method of example 1 can further include disentangling a reflectance associated with environmental lighting and relighting the image point based on an environmental map.

Example 8. The method of example 1, wherein the generating of the image point can include changing a view direction and/or a gaze direction of the eye.

Example 9. The method of example 2, wherein the generating of the albedo and the SH coefficients can include processing a trained Neural Radiance Fields (NeRF) with Spherical Harmonics Lighting (SHL) model with the transformed first point and the warped second point as inputs.

Example 10. The method of example 9, wherein the NeRF-SHL model can be trained with a subject at least one of following a mobile camera with a gaze of the subject while keeping their head static and forward facing, focusing on a first static camera and changing the gaze of the subject to a second static camera, and focusing on the first static camera and rotating a head of the subject in a pattern with eyes of the subject static.

Example 11 is another method for synthesizing an image according to an example implementation. Example 11 can be a variation of FIG. 9. The method includes selecting a first point from a 3D model representing an avatar, the first point being associated with an eye, selecting a second point from the 3D model, the second point being associated with a periocular region associated with the eye, generating an albedo and spherical harmonics (SH) coefficients based on the first point and the second point, and generating an image point based on the albedo, and the SH coefficients.

Example 12. The method of Example 11 can further include storing a plurality of image points using the generated image point and generating an image representing the avatar based on a plurality of image points.

Example 13. The method of Example 12, wherein the generating of the image representing the avatar can includes rendering the image representing the avatar using raytracing to compute reflection rays and refraction rays.

Example 14. The method of Example 11, wherein the generating of the albedo and the SH coefficients can include processing a trained Neural Radiance Fields (NeRF) with Spherical Harmonics Lighting (SHL) model with the first point and the second point as inputs.

Example 15. The method of Example 14, wherein the NeRF-SHL model can be trained with a subject at least one of following a mobile camera with a gaze of the subject while keeping their head static and forward facing, focusing on a first static camera and changing the gaze of the subject to a second static camera, and focusing on the first static camera and rotating a head of the subject in a pattern with eyes of the subject static.

Example 16. The method of Example 11 can further include disentangling a reflectance associated with environmental lighting and relighting the image point based on an environmental map.

Example 17. The method of Example 11, wherein the generating of the image point can include changing a view direction and/or a gaze direction of the eye.

Example 18. A method can include any combination of one or more of Example 1 to Example 17.

Example 19. A non-transitory computer-readable storage medium comprising instructions stored thereon that, when executed by at least one processor, are configured to cause a computing system to perform the method of any of Examples 1-18.

Example 20. An apparatus comprising means for performing the method of any of Examples 1-18.

Example 21. An apparatus comprising at least one processor and at least one memory including computer program code, the at least one memory and the computer program code configured to, with the at least one processor, cause the apparatus at least to perform the method of any of Examples 1-18.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASIC s (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device to generate an augmented environment for viewing inserted content within the physical space. For example, one or more sensors included on a computing device or other computing device depicted in the figure, can provide input to the AR headset or in general, provide input to an AR space. The sensors can include, but are not limited to, a touchscreen, accelerometers, gyroscopes, pressure sensors, biometric sensors, temperature sensors, humidity sensors, and ambient light sensors. The computing device can use the sensors to determine an absolute position and/or a detected rotation of the computing device in the AR space that can then be used as input to the AR space. For example, the computing device AAA50 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
identifying an eye in a three-dimensional (3D) model representing an avatar;
selecting a first point from the 3D model based on the identified eye;
selecting a second point from the 3D model based on the identified eye;
transforming the first point;
warping the second point;
generating an albedo and spherical harmonics (SH) coefficients based on the transformed first point and the warped second point; and
generating an image point based on the albedo and the SH coefficients.

2. The method of claim 1, further comprising:
storing a plurality of image points using the generated image point; and
generating an image representing the avatar based on a plurality of image points.

3. The method of claim 2, wherein the generating of the image representing the avatar includes rendering the image representing the avatar using raytracing to compute reflection rays and refraction rays.

4. The method of claim 1, wherein the SH coefficients include specular SH coefficients and diffuse SH coefficients.

5. The method of claim 1, wherein the transforming of the first point includes explicit modeling of a surface of the eye.

6. The method of claim 1, wherein the warping of the second point includes generating a deformable volumetric reconstruction for a periocular region associated with the eye.

7. The method of claim 1, further comprising:
disentangling a reflectance associated with environmental lighting; and
relighting the image point based on an environmental map.

8. The method of claim 1, wherein the generating of the image point includes changing a view direction of the eye.

9. The method of claim 1, wherein the generating of the albedo and the SH coefficients includes processing a trained Neural Radiance Fields (NeRF) with Spherical Harmonics Lighting (SHL) model with the transformed first point and the warped second point as inputs.

10. The method of claim 9, wherein the NeRF-SHL model is trained with a subject at least one of:
following a mobile camera with a gaze of the subject while keeping their head static and forward facing;
focusing on a first static camera and changing the gaze of the subject to a second static camera; and
focusing on the first static camera and rotating a head of the subject in a pattern with eyes of the subject static.

11. A method comprising:
selecting a first point from a 3D model representing an avatar, the first point being associated with an eye;
selecting a second point from the 3D model, the second point being associated with a periocular region associated with the eye;
generating an albedo and spherical harmonics (SH) coefficients based on the first point and the second point; and
generating an image point based on the albedo, and the SH coefficients.

12. The method of claim 11, further comprising:
storing a plurality of image points using the generated image point; and
generating an image representing the avatar based on a plurality of image points.

13. The method of claim 12, wherein the generating of the image representing the avatar includes rendering the image representing the avatar using raytracing to compute reflection rays and refraction rays.

14. The method of claim 11, wherein the generating of the albedo and the SH coefficients includes processing a trained Neural Radiance Fields (NeRF) with Spherical Harmonics Lighting (SHL) model with the first point and the second point as inputs.

15. The method of claim 14, wherein the NeRF-SHL model is trained with a subject at least one of:
following a mobile camera with a gaze of the subject while keeping their head static and forward facing;
focusing on a first static camera and changing the gaze of the subject to a second static camera; and
focusing on the first static camera and rotating a head of the subject in a pattern with eyes of the subject static.

16. The method of claim 11, further comprising:
disentangling a reflectance associated with environmental lighting; and
relighting the image point based on an environmental map.

17. The method of claim 11, wherein the generating of the image point includes changing a view direction of the eye.

18. A non-transitory computer-readable storage medium comprising instructions stored thereon that, when executed by at least one processor, are configured to cause a computing system to:
select a first point from a 3D model representing an avatar, the first point being associated with an eye;
select a second point from the 3D model, the second point being associated with a periocular region associated with the eye;
generate an albedo and spherical harmonics (SH) coefficients based on the first point and the second point; and
generate an image point based on the albedo, and the SH coefficients.

19. The non-transitory computer-readable storage medium of claim 18, wherein the instructions are further configured to cause the computing system to render a plurality of image points representing the avatar using raytracing to compute reflection rays and refraction rays to generate an image representing the avatar.

20. The non-transitory computer-readable storage medium of claim 18, wherein the generating of the albedo and the SH coefficients includes processing a trained Neural Radiance Fields (NeRF) with Spherical Harmonics Lighting (SHL) model with a transformed first point and a warped second point as inputs.
